(19) United States
(12) Patent Application Publication
(10) Pub. No.: US 2012/0179994 A1
(43) Pub. Date: Jul. 12, 2012

(54) METHOD FOR MANIPULATING A TOOLBAR ON AN INTERACTIVE INPUT SYSTEM AND INTERACTIVE INPUT SYSTEM EXECUTING THE METHOD

(75) Inventors: Nancy Knowlton, Calgary (CA); Kathryn Rounding, Calgary (CA); Erin Wallace, Calgary (CA); Gregory G. Forrest, Calgary (CA)

(73) Assignee: SMART Technologies ULC, Calgary (CA)

(21) Appl. No.: 13/349,280

(22) Filed: Jan. 12, 2012

Related U.S. Application Data
(60) Provisional application No. 61/431,849, filed on Jan. 12, 2011.

(51) Int. Cl. G06F 3/048; G09G 5/00

(52) U.S. Cl. 715/779; 345/672; 715/810

(57) ABSTRACT

A method comprises receiving input; and when said input is associated with a command to transpose a graphical user interface (GUI) element comprising a plurality of sub-elements that is positioned on a display surface, transposing at least one of said sub-elements.

### CROSS-REFERENCE TO RELATED APPLICATIONS

This application claims the benefit of U.S. Provisional Application No. 61/431,849 entitled “METHOD FOR MANIPULATION TOOLBAR ON AN INTERACTIVE INPUT SYSTEM AND INTERACTIVE INPUT SYSTEM EXECUTING THE METHOD”, filed on Jan. 12, 2011, the content of which is incorporated herein by reference in its entirety. This application is also related to U.S. Patent Application Publication No. 2011/0298722 to Tse et al. entitled “INTERACTIVE INPUT SYSTEM AND METHOD” filed on Jun. 4, 2010, the content of which is incorporated herein by reference in its entirety.

### FIELD OF THE INVENTION

The present invention relates generally to a method and apparatus for manipulating graphical user interface elements.

### BACKGROUND OF THE INVENTION

Menus and toolbars are common features of software application graphical user interfaces. As is well known, a toolbar is a panel comprising a tool set, which includes one or more selectable tools (or tool buttons) represented by graphic objects such as for example text, images, icons, characters, thumbnails, etc. Each selectable tool is associated with a function that is executable upon selection of the tool. A toolbar thus provides an easy way for a user to select certain desktop or other application functions, such as saving or printing a document.

While efforts have been made to make software application graphical user interfaces more user-friendly, there still remains a number of drawbacks with graphical user interfaces. For instance, SMART Notebook™ Version 10.6 offered by SMART Technologies ULC. of Calgary, Alberta, Canada, the assignee of the subject application, allows customization of its graphical user interface menu, toolbar or sidebar settings, such as language, in order to cater to specific audiences. Consequently, when the language is set to “English”, the graphical user interface layout is arranged in a left-to-right reading direction, whereas when the language is set to some Semitic languages, such as Hebrew or Arabic, the graphical user interface layout is arranged in a right-to-left reading direction. SMART Notebook™ also allows a user to change the location of the toolbar from a default position at the top of the application window to the bottom thereof by selecting a toolbar relocation button, however, the arrangement of the tools of the toolbar remain unchanged. Likewise, the sidebar may be moved horizontally from one the side of the application window to the other by selecting a sidebar relocation button, however the arrangement of graphic objects (e.g., whiteboard page thumbnails, icons, text) contained therein remains unchanged. The use of the relocation buttons has been found not to be ideal for relatively large interactive displays, such as interactive whiteboards (IWBs). For example, a user standing adjacent one side of the IWB may be required to walk back and forth to actuate the relocation buttons in order to have the toolbar and/or sidebar conveniently located for easy access during a presentation. In addition, the selectable tools of the toolbar and the graphic objects of the sidebar may be ordered in only one of two ways, left to right or right to left for a horizontal toolbar or top to bottom or bottom to top for a vertical sidebar.

It is thus an object of the present invention to mitigate or obviate at least one of the above-mentioned disadvantages.

### SUMMARY OF THE INVENTION

Accordingly, in one aspect there is provided a method comprising receiving input; and when said input is associated with a command to transpose a graphical user interface (GUI) element comprising a plurality of sub-elements that is positioned on a display surface, transposing at least one of said sub-elements within said GUI element.

In one embodiment, during the transposing, a plurality of the sub-elements is transposed. During transposing, the position of a plurality of the sub-elements or the position of all of the sub-elements may be shifted in a specified direction. Also, the order of the shifted sub-elements may be reversed. Further, the reading direction of text of the shifted sub-elements may be reversed.

In another embodiment, the sub-elements are arranged in groups. During transposing, the position of the sub-elements may be shifted in a specified direction. The shifted sub-elements may also be reversed ordered.

In another aspect there is provided a non-transitory computer-readable medium having instructions embodied thereon, said instructions being executed by processing structure to cause the processing structure to process received input; determine whether said input is associated with a command to transpose a graphical user interface (GUI) element comprising a plurality of sub-elements on a display coupled to said processor; and when said input is associated with said command is detected, transpose at least one of said sub-elements.

In another aspect there is provided a computer program product including program code embodied on a computer readable medium, the computer program product comprising program code for presenting a toolbar comprising a plurality of selectable buttons in an ordered state on a graphical user interface; program code for receiving input; and program code for arranging and displaying the buttons within the toolbar in another ordered state in response to said input.

In another aspect there is provided an interactive input system comprising computing structure; and a display coupled to said computing structure, said display presenting at least one graphical user interface (GUI) element comprising a plurality of sub-elements, said computing structure transposing at least one of said sub-elements within said GUI element in response to input received by said computing structure.

In yet another aspect there is provided an apparatus comprising processing structure receiving input data; and memory storing computer program code, which when executed by the processing structure, causes the apparatus to determine whether said input data is associated with a command to change the display order of at least one selectable icon within a graphical user interface (GUI) element comprising a plurality of icons; and when said input data is associated with said command, transpose said at least one selectable icon.

In still yet another aspect there is provided a method comprising receiving input; and when said input is associated with a command to transpose a graphical user interface (GUI) element comprising a sub-element on a display, changing at least one of the position and the reading direction of said sub-element within the GUI element.

### BRIEF DESCRIPTION OF THE DRAWINGS

Embodiments will now be described more fully with reference to the accompanying drawings in which:

FIG. 1 is a perspective view of an interactive input system;

FIG. 2 is a schematic diagram showing the software architecture of the interactive input system of FIG. 1;

FIG. 3 is a flowchart showing exemplary steps performed by an application for transposing graphical user interface sub-elements;

FIGS. 4A and 4B show a portion of an application window having a toolbar that comprises a toolbar transposing button;

FIGS. 5A and 5B show an application window having a toolbar and a sidebar according to an alternative embodiment;

FIGS. 6A to 6C show an alternative interactive whiteboard for the interactive input system that comprises proximity sensors; and

FIGS. 7 to 15 illustrate toolbar layouts in accordance with various predefined rules.

### DETAILED DESCRIPTION OF THE EMBODIMENTS

In the following, a method and apparatus for manipulating a graphical user interface are described. When input associated with a command to transpose a displayed graphical user interface (GUI) element comprising a plurality of GUI sub-elements is received, at least one of the GUI sub-elements is transposed (i.e. its position on the GUI element is changed).

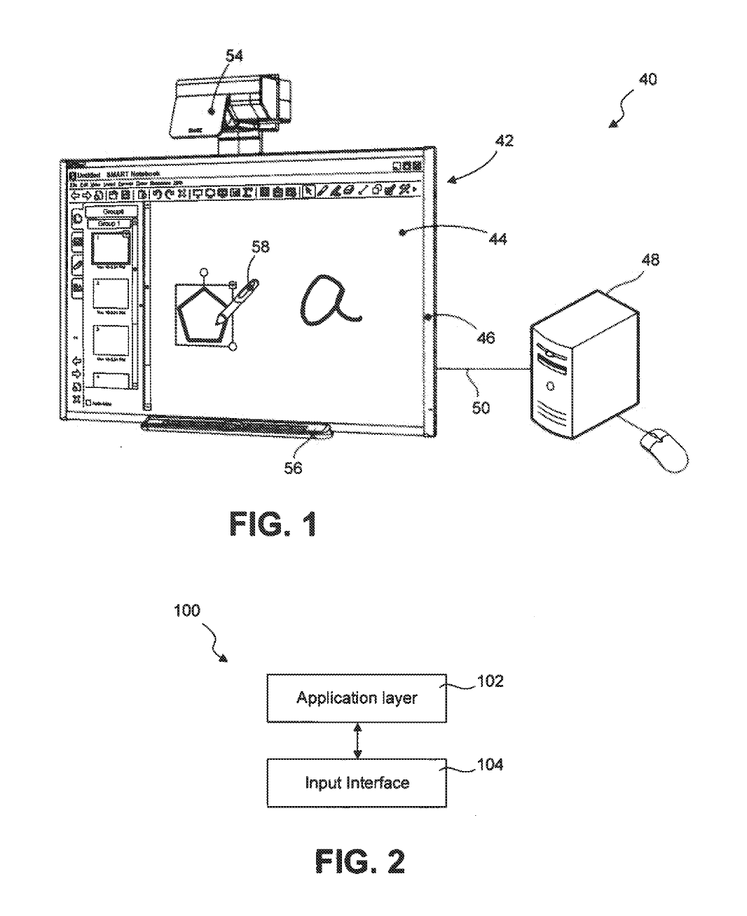

Turning now to FIG. 1, an interactive input system is shown and is generally identified by reference numeral 40. Interactive input system 40 allows a user to inject input such as digital ink, mouse events, commands, etc. into an executing application program. In this embodiment, interactive input system 40 comprises a two-dimensional (2D) interactive device in the form of an interactive whiteboard (IWB) 42 mounted on a vertical support surface such as for example, a wall surface or the like. IWB 42 comprises a generally planar, rectangular interactive surface 44 that is surrounded about its periphery by a bezel 46. An ultra short throw projector 54 such as that sold by SMART Technologies ULC of Calgary, Alberta under the name “SMART UX60” is mounted on the support surface above the IWB 42 and projects an image, such as for example, a computer desktop, onto the interactive surface 44.

The IWB 42 employs machine vision to detect one or more pointers brought into a region of interest in proximity with the interactive surface 44. The IWB 42 communicates with a general purpose computing device 48 executing one or more application programs via a universal serial bus (USB) cable 50 or other suitable wired or wireless communication link. Computing device 48 processes the output of the IWB 42 and adjusts image data that is output to the projector 54, if required, so that the image presented on the interactive surface 44 reflects pointer activity. In this manner, the IWB 42, computing device 48 and projector 54 allow pointer activity proximate to the interactive surface 44 to be recorded as writing or drawing or used to control execution of one or more application programs executed by the computing device 48.

The bezel 46 is mechanically fastened to the interactive surface 44 and comprises four bezel segments that extend along the edges of the interactive surface 44. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces lie in a plane generally normal to the plane of the interactive surface 44.

A tool tray 56 is affixed to the IWB 42 adjacent the bottom bezel segment using suitable fasteners such as for example, screws, clips, adhesive, friction fit, etc. As can be seen, the tool tray 56 comprises a housing having an upper surface configured to define a plurality of receptacles or slots. The receptacles are sized to receive one or more pen tools 58 as well as an eraser tool 60 that can be used to interact with the interactive surface 44. Control buttons are also provided on the upper surface of the tool tray housing to enable a user to control operation of the interactive input system 40. Further specifics of the tool tray 56 are described in U.S. Patent Application Publication No. 2011/0169736 to Bolt et al., filed on Feb. 19, 2010, and entitled “INTERACTIVE INPUT SYSTEM AND TOOL TRAY THEREFOR”.

Imaging assemblies (not shown) are accommodated by the bezel 46, with each imaging assembly being positioned adjacent a different corner of the bezel. Each of the imaging assemblies comprises an image sensor and associated lens assembly. The lens has an IR pass/visible light blocking filter thereon and provides the image sensor with a field of view sufficiently large as to encompass the entire interactive surface 44. A digital signal processor (DSP) or other suitable processing device sends clock signals to the image sensor causing the image sensor to capture image frames at the desired frame rate. During image frame capture, the DSP also causes an infrared (IR) light source to illuminate and flood the region of interest over the interactive surface 44 with IR illumination. Thus, when no pointer exists within the field of view of the image sensor, the image sensor sees the illumination reflected by the retro-reflective bands on the bezel segments and captures image frames comprising a continuous bright band. When a pointer exists within the field of view of the image sensor, the pointer occludes reflected IR illumination and appears as a dark region interrupting the bright band in captured image frames.

The imaging assemblies are oriented so that their fields of view overlap and look generally across the entire interactive surface 44. In this manner, any pointer 58 such as for example a user's finger, a cylinder or other suitable object, or a pen or eraser tool lifted from a receptacle of the tool tray 56, that is brought into proximity of the interactive surface 44 appears in the fields of view of the imaging assemblies and thus, is captured in image frames acquired by multiple imaging assemblies. When the imaging assemblies acquire image frames in which a pointer exists, the imaging assemblies convey pointer data to the computing device 48.

The general purpose computing device 48 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The computing device 48 may also comprise networking capabilities using Ethernet, WiFi, and/or other suitable network format, to enable connection to shared or remote drives, one or more networked computers, or other networked devices. The computing device 48 processes the pointer data received from the imaging assemblies and computes the location of the pointer proximate the interactive surface 44 using well known triangulation methods. The computed pointer location is then recorded as writing or drawing or used an input command to control execution of an application program as described above.

FIG. 2 shows the software architecture of the interactive input system 40, and is generally identified by reference numeral 100. The software architecture 100 comprises an application layer 102 comprising one or more application programs and an input interface 104 that receives input from input devices such as the IWB 42, a mouse, a keyboard, or other input device communicating with the computing device 48 depending on the interactive input system configuration. The input interface 104 interprets the received input as various input events, and then passes these input events to the application layer 102.

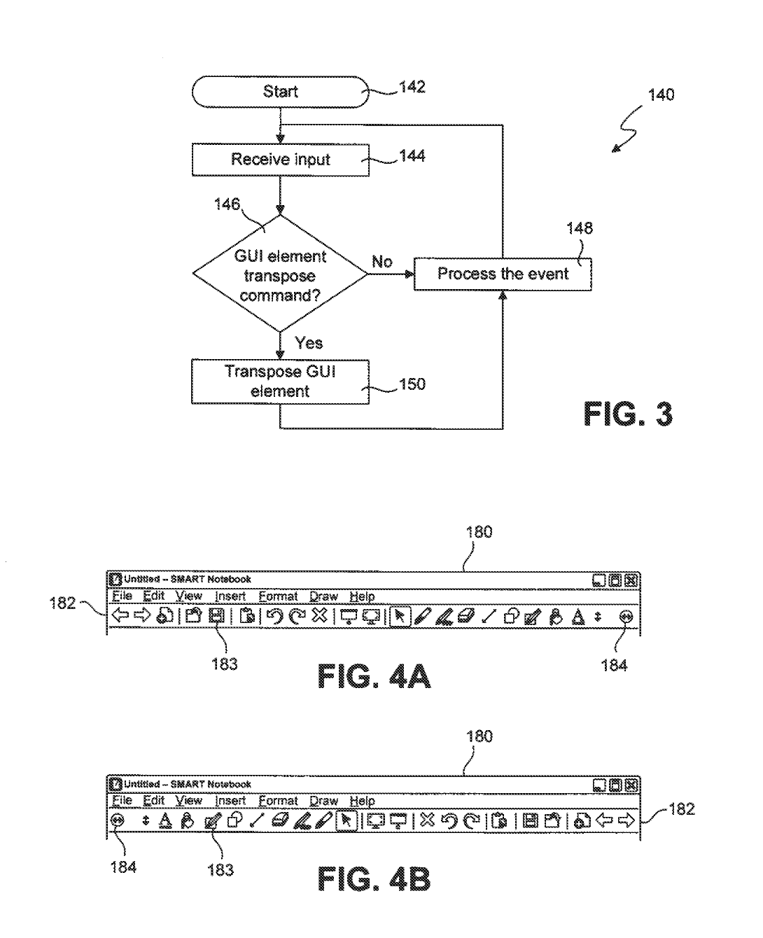

Turning now to FIG. 3, there is illustrated a flowchart showing exemplary steps performed at the application layer 102 to transpose a displayed graphical user interface (GUI) element in response to a GUI element transpose command, which is generally identified by reference numeral 140. Generally, a GUI element may take a variety of forms, such as for example, a window, screen, dialogue box, menu, toolbar, sidebar, icon, button, box, field, a list etc. In this embodiment, the application layer 102 comprises a SMART Notebook™ application that runs on the computing device 48. When launched, the graphical user interface of the SMART Notebook™ application is displayed on the interactive surface 44 in an application window and comprises a menu, a toolbar, and a sidebar as shown in FIG. 1.

After the application has been launched (step 142), and the application receives an input event from the input interface 104 (step 144), the application processes the input event to determine the command conveyed therein (step 146). When it is determined that the input event comprises a command for transposing a GUI element, the application transposes the GUI element according to predefined rules (step 150), as will be described later. The process then proceeds to step 148 to further process the input event, when the input event includes other commands, and then proceeds to step 144 to await receipt of the next input event. At step 146, if the input event is not a command for transposing a GUI element, the application processes the input event in a conventional manner (step 148), and then proceeds to step 144 to await receipt of the next input event.

Various input events may be interpreted as a GUI transposing command at step 146, depending on interactive input system design. For example, as shown in FIG. 4A, a portion of the SMART Notebook™ application window 180 is illustrated and comprises a toolbar 182 with a plurality of tool buttons 183 arranged in a certain left to right order together with a toolbar transposing button 184 positioned adjacent the right end of the toolbar 182. Actuation of the toolbar transposing button 184 causes the SMART Notebook™ application to transpose the toolbar 182 by re-arranging the tool buttons 183 thereof such that the toolbar 182 is “mirrored”, as shown in FIG. 4B. Therefore, the order of the tool buttons 183 in the toolbar 182 in FIG. 4B is reversed. Actuation of the toolbar transposing button 184 when it is positioned adjacent the left end of the toolbar 182 as shown in FIG. 4B causes the order of the tool buttons 183 to revert back to that shown in FIG. 4A.

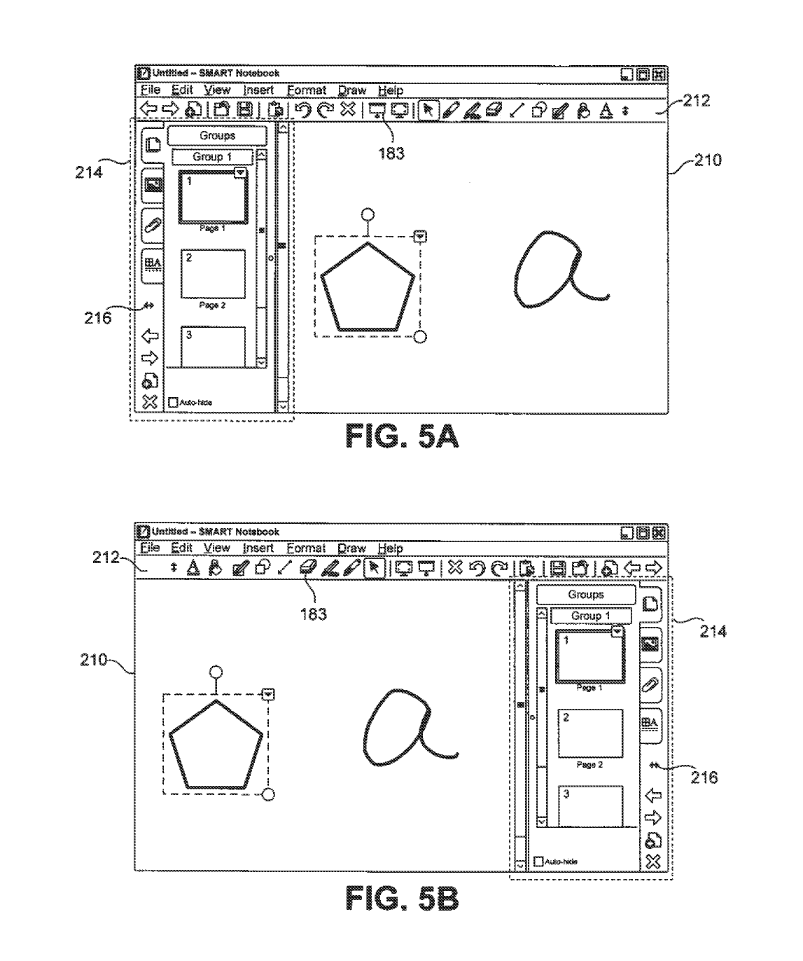

FIG. 5A shows the application window 210 of another embodiment of the SMART Notebook™ application. In this embodiment, the application window 210 comprises a toolbar 212 having a plurality of tool buttons 183 arranged in a certain left to right order and a sidebar 214 along the left side of a drawing area. The sidebar 214 comprises a plurality of tabbed groups and tool buttons together with a sidebar transposing button 216, as shown in FIG. 5A. When the application detects actuation of the sidebar transposing button 216, the application re-arranges the tool buttons 183 such that the toolbar 182 is “mirrored”, and simultaneously moves the sidebar 214 to the right side of the drawing area, as shown in FIG. 5B. Actuation of the sidebar transposing button 216 when the sidebar 214 is positioned along the right side of the drawing area as shown in FIG. 5B causes the order of the tool buttons 183 to revert back to that shown in FIG. 5A, and simultaneously moves the sidebar 214 back to the left side of the drawing area, as shown in FIG. 5A.

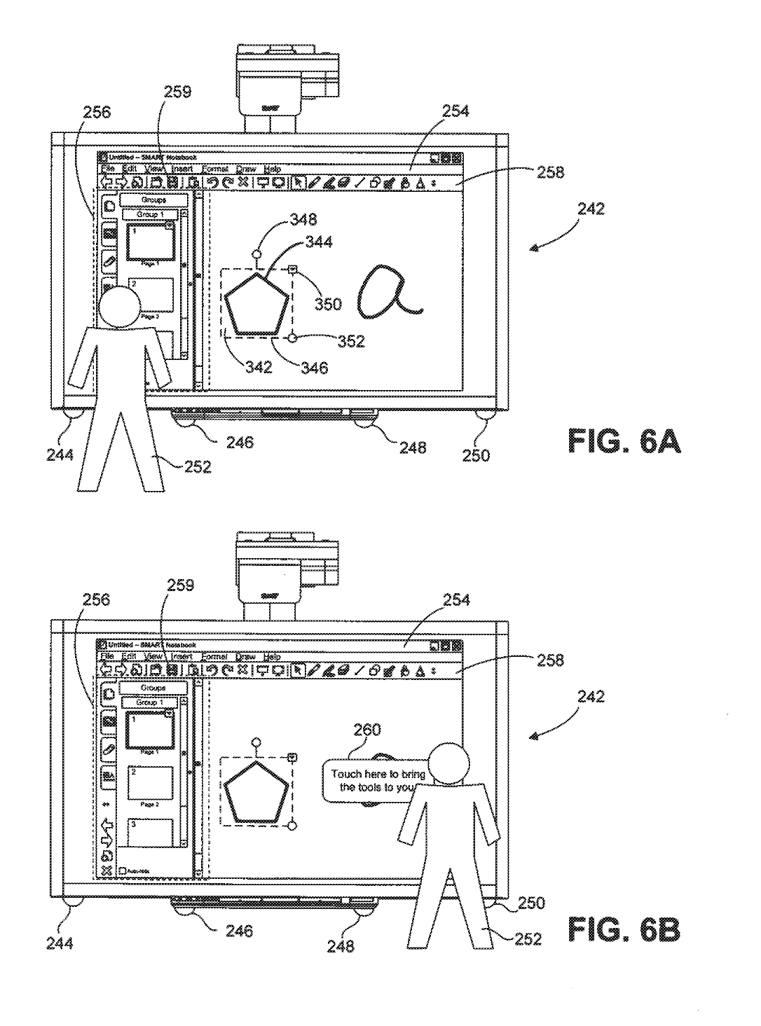

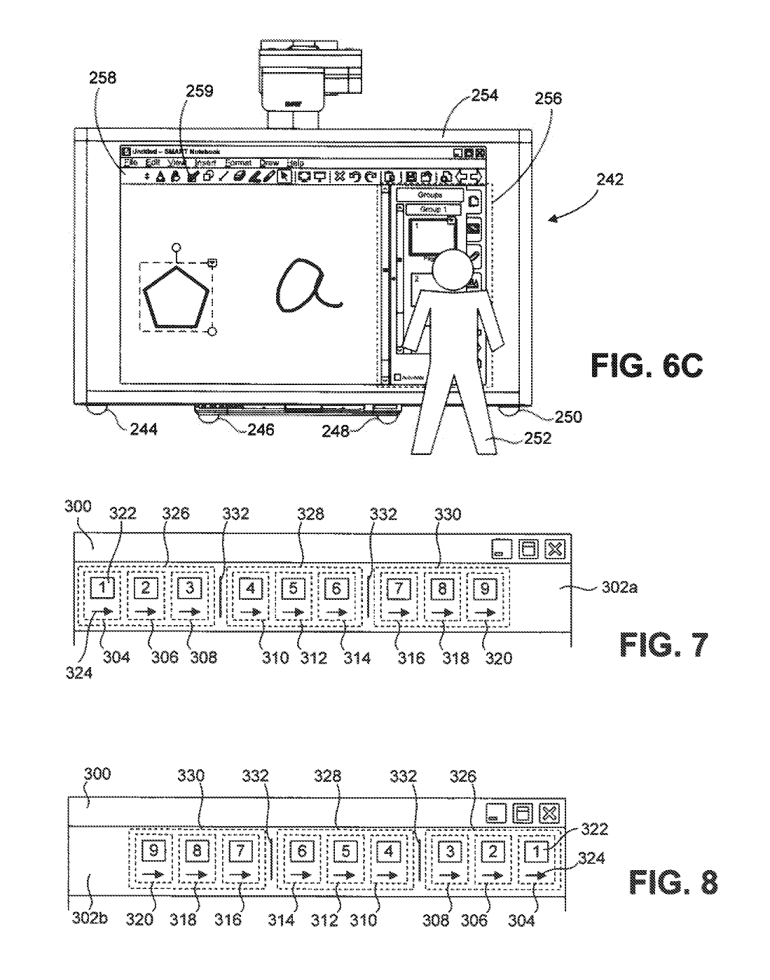

In yet another embodiment, the interactive input system 40 comprises an IWB 242 that enables a displayed GUI element to be transposed based on the location of a user with respect to the IWB 242, as shown in FIGS. 6A to 6C. In this embodiment, the IWB 242 is very similar to that shown in FIG. 1 but further comprises four proximity sensors 244 to 250 positioned at spaced locations along the bottom bezel segment. During user interaction with the IWB 242, the computing device 48 analyzes the output of the proximity sensors 244 to 250 to detect the presence and location of a user near the IWB 242. Specifics of user presence and location detection using proximity sensors are disclosed in above-incorporated U.S. Patent Application Publication No. 2011/0298722 to Tse et al. The application window 254 of the SMART Notebook™ application running on the computing device 48 is presented on the interactive surface of the IWB 242. The application window 254 comprises a sidebar 256 and a toolbar 258. As shown in FIG. 6A, when a user 252 is determined to be positioned adjacent the left side of the IWB 242 following processing of the proximity sensor output, the application docks the sidebar 256 to the left side of the application window 254, and arranges the tool buttons 259 in the toolbar 258 from left to right. When the user 252 moves to the right side of the IWB 242, and the user's change in location is determined following processing of the proximity sensor output, the application displays a dialogue box 260 at the right side of the window 254 prompting the user to touch the dialogue box 260 in order to transpose the toolbar 258 and the sidebar 256, as shown in FIG. 6B. Touching the dialogue box 260 provides a command to the application 102 to move the sidebar 256 to the right side of the application window 254, and reverse the order of the tool buttons 259 in the toolbar 258.

Similarly, when the user again moves to the left side of the IWB 242, and the user's change in location is determined following processing of the proximity sensor output, a dialogue box 260 is displayed at the left side of the application window 254 prompting the user to touch the dialogue box 260 to transpose the sidebar 256 and the toolbar 258. After the user touches the dialogue box 260, the application moves the sidebar 256 to the left side of the application window 254, and reverses the order of the tool buttons 259 in the toolbar 258.

Alternatively, the toolbar 258 may be automatically rearranged when a change in location of the user is determined following processing of the proximity sensor, thus obviating the need for user intervention via the dialogue box 260, or otherwise. The interactive input system 240 may employ any number of proximity sensors to detect a user's presence and location near the IWB 242. In some related embodiments, the proximity sensors may be installed at various locations on the IWB 242. In other embodiments, some of the proximity sensors may be installed on the IWB 242, and some of the proximity sensors may be installed on supportive structure (e.g., wall) near the IWB 242.

It should be noted that other GUI elements, such as, the menu bar, tool box, control interface of graphic objects (e.g., as shown in FIG. 6A, the control interface 342 of the graphic object 344, including the bounding box 346, the rotation handle 348, the context menu button 350 and the scaling handle 352), etc., may be transposed in a similar manner after the application receives a transposing command.

Now turning to FIGS. 7 to 14, various toolbar layouts in accordance with different transposing rules are shown. FIG. 7 shows a portion of a window 300 comprising a toolbar 302a. The toolbar 302a comprises a plurality of tool buttons 304 to 320, with each tool button 304 to 320 comprising an icon 322 and text (not shown) arranged to have a reading direction indicated by the arrow 324. The tool buttons 304 to 320 are organized into tool groups 326 to 330, and the tool groups 326 to 330 are arranged in a certain left to right order, with separators 332 therebetween. Usually, each tool group 326 to 330 comprises tool buttons 304 to 320 with related or similar functions, or tasks.

In one embodiment, in response to the GUI transposing command, the tool bar 302a of the application window 300 is transposed according a first predefined rule resulting in a transposed toolbar 302b as shown in FIG. 8. As can be seen, in the transposed toolbar 302b, the tool buttons 304 to 320, and consequently the tool groups 326 to 330, have been shifted to the right end of the toolbar 302b, and the order of the tool buttons 304 to 320 has been reversed. However, the icon 322 and text of each tool button 304 to 320 has not been changed and as a result the text is still in the same reading direction.

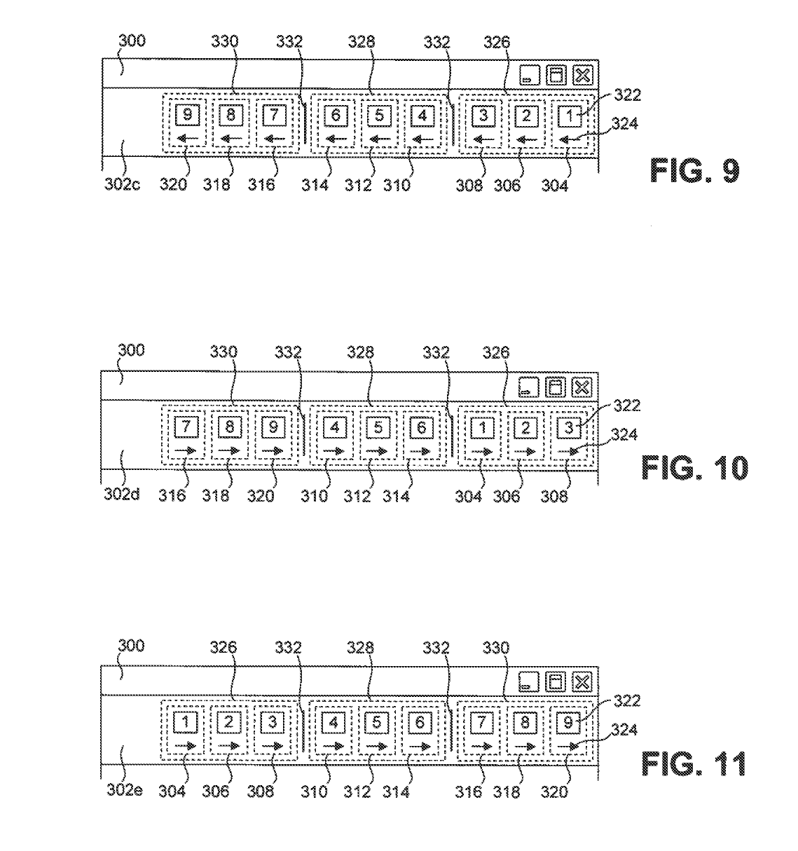

In another embodiment, in response to the GUI transposing command, the tool bar 302a of the application window 300 is transposed according a second predefined rule resulting in a transposed toolbar 302c, as shown in FIG. 9. In the transposed toolbar 302c, the tool buttons 304 to 320, and consequently the tool groups 326 to 330, have been shifted to the right end of the toolbar 302c, and the order of the tool buttons 304 to 320 has been reversed. Although the icon 322 of each tool button 304 to 320 has not been changed, the reading direction of the text of each tool button has been reversed.

In another embodiment, in response to the GUI transposing command, the tool bar 302a of the application window 300 is transposed according a third predefined rule resulting in a transposed toolbar 302d, as shown in FIG. 10. In the transposed toolbar 302d, the tool groups 326 to 330 have been shifted to the right end of the toolbar 302d, and the order of the tool groups 326 to 330 has been reversed. However, the order of the tool buttons 304 to 320 within each tool group, as well as the icon 322 and text of each tool button 304 to 320, has not been changed.

In another embodiment, in response to the GUI transposing command, the tool bar 302a of the application window 300 is transposed according a fourth predefined rule resulting in a transposed toolbar 302e, as shown in FIG. 11. In the transposed toolbar 302d, the tool buttons 304 to 320, and therefore the tool groups 326 to 330, have been shifted to the right end of the toolbar 302e.

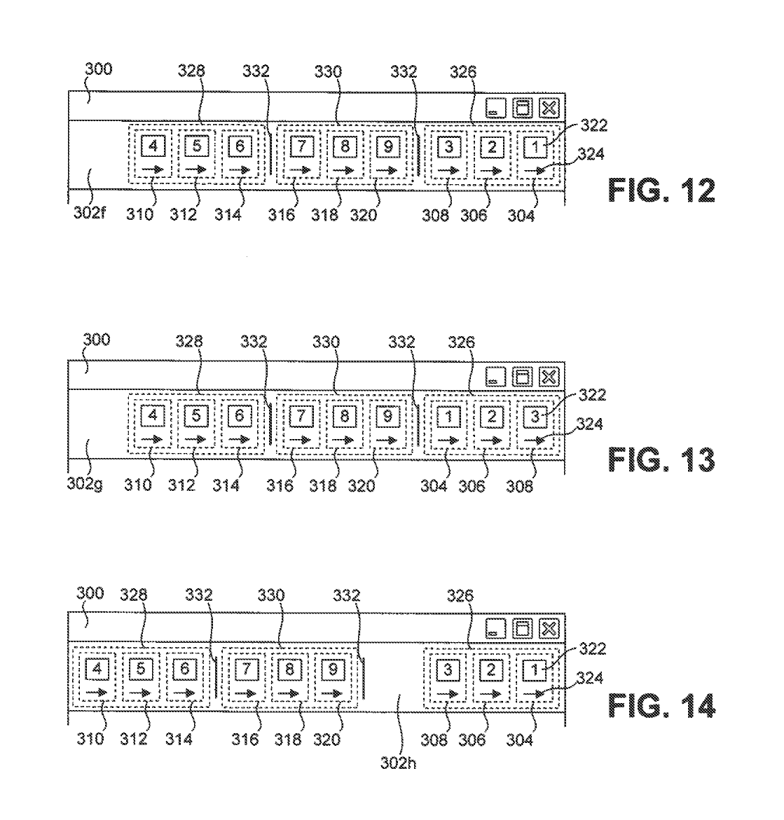

In yet another embodiment, some of the tool groups 326 to 330 may comprise important or frequently used tool buttons. For example, referring to FIGS. 7 and 12, the tool group 326 is predefined or is set by an option, as comprising frequently used tool buttons 304 to 308. In this case, the toolbar 302a in response to the GUI transposing command is transposed according to a fifth predefined rule resulting in transposed toolbar 302f, as shown in FIG. 12. In the transposed toolbar 302f, the tool group 326 has been moved to the right end of the toolbar 302f, and the order of the tool buttons 304 to 308 in the tool group 326 has been reversed. The other tool groups 328 and 330 have been shifted towards the tool group 326 but the order of tool buttons 310 to 320 in the tool groups 330 and 328 has not been changed.

In yet another related embodiment, tool group 326 also comprises frequently used tool buttons 304 to 308. In this case, the toolbar 302a in response to the GUI transposing command is transposed according to a sixth predefined rule resulting in transposed toolbar 302g, as shown in FIG. 13. In the transposed toolbar 302g, the tool group 326 has been moved to the right end of the toolbar 302g but the order of the tool buttons 304 to 308 has not been changed. The other tool groups 330 and 328 have been shifted towards the tool group 326 but the order of tool buttons 310 to 320 in the tool groups 330 and 328 has not been changed.

In yet another related embodiment, tool group 326 also comprises frequently used tool buttons 304 to 308. In this case, the toolbar 302a in response to the GUI transposing command is transposed according to a seventh predefined rule resulting in transposed toolbar 302h, as shown in FIG. 14. In the transposed toolbar 302h, the tool group 326 comprising frequently used tool buttons 304 to 308 has been moved to the right end of the toolbar 302h, while the other tool groups 328 and 330 have been shifted to the left end of the toolbar 302h. The order of the tool buttons 304 to 308 in tool group 326 has been reversed. The order of the tool buttons 304 to 308 in tool groups 328 and 330 however has not been changed.

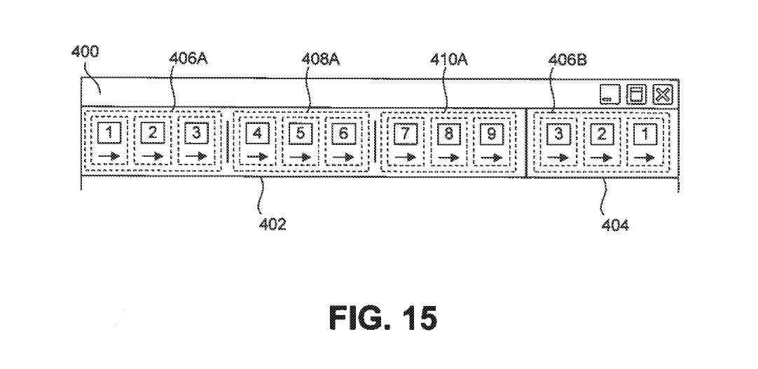

Although the above embodiments have been described with reference to a single user, in other embodiments, the interactive input system 240 allows two or more users to interact with the IWB simultaneously. For example, when it has been detected that two or more users are simultaneously interacting with the IWB 242 (based on the output of the proximity sensors, or based on the detection of two simultaneous touches), the application is configured to present two toolbars within the application window. Each of the toolbars comprises the same tool set but in a different tool button arrangement (e.g., one toolbar is “mirrored” from the other). The two toolbars 402 and 404 may be arranged in the same row (or same column, depending on interactive input system design), with some tool groups 406, 408, 410 or tool buttons being hidden, as shown in FIG. 15. Each toolbar 402 and 404 comprises the same tool groups 406, 408, 410. However, the tool groups 408B and 410B on toolbar 404 are hidden (therefore not shown), and thus the toolbar 404 only comprises the tool group 406B, which is the rearranged version of tool group 406A in toolbar 402. Alternatively, the application may be configured to monitor the usage of the tool buttons or tool groups 406, 408, 410 to determine which tool buttons or tool groups 406, 408, 410 to hide. For example, less frequently used tool groups 406, 408 or 410 are hidden when two toolbars 402 and 404 are arranged in the same row, and the more frequently used tool groups 406, 408 or 410 are always shown.

If desired, proximity sensors may be mounted on the projector 54 that look generally towards the IWB 42 to detect the user's presence and location. Alternatively, one or more cameras may be installed on the projector 54 that look generally towards the IWB 42. In this case, the cameras capture images of the interactive surface as well as any user in front thereof, allowing the user's location from the captured images to be determined and the GUI elements transposed accordingly. Specifics of detecting the user's location from captured images is disclosed in U.S. Pat. No. 7,686,460 to Holmgren, et al., assigned to SMART Technologies ULC, the assignee of the subject application, the content of which is incorporated herein by reference in its entirety.

In another embodiment, the imaging assemblies of the IWB 42 are used to detect both pointer contacts on the interactive surface and to detect the presence and location of the user. In this case, the imaging assemblies accommodated by the bezel look generally across and slightly forward of the interactive surface to detect both pointer contacts on the interactive surface and the presence and location of the user. This allows the toolbar to be transposed based on the user's location as described above.

In another embodiment, the toolbar may be rearranged based on the position of pointer contact made on the interactive surface. In this example, the number of pointer contacts on the interactive surface is counted. If the number of pointer contacts consecutively occurring adjacent one side of the IWB 42 exceeds a threshold, the user is determined to be at the same side of the pointer contacts, and the toolbar is rearranged accordingly.

Although in embodiments described above the IWB 42 uses imaging assemblies to detect pointer contact on the interactive surface 44, in other embodiments, the interactive input system may comprise an IWB employing other pointer input registering technologies, such as for example, analog resistive, electromagnetic, projected capacitive, infrared grid, ultrasonic, or other suitable technologies. For example, an analog resistive interactive whiteboard such as the model SMART Board 600i or SMART Board 685ix offered by SMART Technologies ULC of Calgary, Alberta, Canada may be used.

Those skilled in the art will appreciate that various alternative embodiments are readily available. For example, in some embodiments, an application may use a different toolbar transposing indication, e.g., a toolbar transposing gesture, to determine whether the toolbar needs to be transposed or not. In some other embodiments where an application comprises multiple toolbars, a toolbar transposing command may cause all toolbars to be transposed, while in other embodiments, each toolbar has its own transposing command.

Although in embodiments described above the toolbar is arranged and transposed horizontally, in other embodiments, an application window may comprise a vertical toolbar and the toolbar which may be transposed vertically.

Although in embodiments described above an IWB is used in the interactive input systems, in other embodiments, the interactive input system does not comprise an IWB. Instead, it uses a monitor or projection screen to display computer-generated images. Also, in other embodiments, the interactive input system may comprise an interactive input device having a horizontal interactive surface, such as for example, a touch sensitive table.

Although in embodiments described above the icons are not mirrored when the toolbar is transposed, in other embodiments, the icons are mirrored when the toolbar is transposed.

Although in embodiments described above the tool buttons are arranged in the toolbar in a row, in other embodiments, tool buttons may be arranged in the toolbar in multiple rows, or in a way so that some tool buttons are arranged in multiple rows and other tool buttons are arranged in one row.

Although in embodiments described above, the tool buttons comprise an icon and a text, in other embodiments, the tool buttons may comprise only an icon or only text.

Although in embodiments described above, all tool buttons are rearranged when a toolbar transposing command is received, in other embodiments, when a toolbar is rearranged, some tool buttons (e.g., some tool buttons or tool groups in the center of the toolbar) may not be rearranged, and thus their locations may not be changed.

Although multiple tool buttons are used in embodiments described above, in other embodiments, a toolbar may comprise only one tool button.

Although in embodiments described above a toolbar transposing button displayed on a display is used to rearrange the toolbar, in other embodiments, a physical button may be used to rearrange the toolbar. Such a physical button may be located on the bezel, the pen tray or other suitable position, depending on interactive input system design.

Although in embodiments described above the toolbar is located in a application window, in other embodiments, the toolbar may be directly positioned on the desktop of the operating system such as Windows®, OSX, Unix, Linux, etc.

Although embodiments have been described above with reference to the accompanying drawings, those of skill in the art will appreciate that variations and modifications may be made without departing from the scope thereof as defined by the appended claims.

What is claimed is:

1. A method comprising:
receiving input; and
when said input is associated with a command to transpose a graphical user interface (GUI) element comprising a plurality of sub-elements that is positioned on a display surface, transposing at least one of said sub-elements within said GUI element.

2. The method of claim 1 wherein said transposing is carried out in accordance with at least one predefined rule.

3. The method of claim 2 wherein said at least one predefined rule comprises at least one of a sub-element shift rule and a sub-element reorder rule.

4. The method of claim 1 wherein during said transposing a plurality of said sub-elements is transposed

5. The method of claim 4 wherein said transposing comprises shifting the position of a plurality of said sub-elements in a specified direction.

6. The method of claim 5 wherein said transposing comprises shifting the position of all of said sub-elements in a specified direction.

7. The method of claim 5 wherein said transposing further comprises reverse ordering the shifted sub-elements.

8. The method of claim 6 wherein said transposing further comprises reverse ordering the shifted sub-elements.

9. The method of claim 7 wherein said transposing further comprises reversing the reading direction of text of the shifted sub-elements.

10. The method of claim 8 wherein said transposing further comprises reversing the reading direction of text of the shifted sub-elements.

11. The method of claim 1 wherein said sub-elements are arranged in groups and wherein said transposing comprises transposing at least one of said groups.

12. The method of claim 11 wherein said transposing comprises shifting the position of said sub-elements in a specified direction.

13. The method of claim 12 wherein said transposing further comprises reverse ordering the shifted sub-elements.

14. The method of claim 13 wherein said transposing further comprises reversing the reading direction of text of the shifted sub-elements.

15. The method of claim 12 wherein said transposing further comprises reverse ordering the sub-elements of a subset of said groups.

16. The method of claim 15 wherein said transposing further comprises reversing the reading direction of text of the shifted sub-elements.

17. The method of claim 1 wherein said input is generated in response to selection of a displayed icon associated with said transpose command.

18. The method of claim 1 further comprising:
detecting the presence and location of a user relative to said display surface; and
generating location data for use as said input.

19. The method of claim 18 wherein said detecting is based on output generated by at least one proximity sensor associated with said display surface.

20. The method of claim 18 wherein said detecting is based on images captured by at least one image sensor in the vicinity of said display surface.

21. The method of claim 18 wherein said detecting further comprises determining the location of user input made on said display surface.

22. A non-transitory computer-readable medium having instructions embodied thereon, said instructions being executed by processing structure to cause the processing structure to:
process received input;
determine whether said input is associated with a command to transpose a graphical user interface (GUI) element comprising a plurality of sub-elements on a display coupled to said processor; and when said input is associated with said command is detected, transpose at least one of said sub-elements.

23. A computer program product including program code embodied on a computer readable medium, the computer program product comprising:
program code for presenting a toolbar comprising a plurality of selectable buttons in an ordered state on a graphical user interface;
program code for receiving input; and
program code for arranging and displaying the buttons within the toolbar in another ordered state in response to said input.

24. An interactive input system comprising:
computing structure; and
a display coupled to said computing structure, said display presenting at least one graphical user interface (GUI) element comprising a plurality of sub-elements, said computing structure transposing at least one of said sub-elements within said GUI element in response to input received by said computing structure.

25. The system of claim 24 wherein said computing structure transposes said at least one sub-element in accordance with at least one predefined rule.

26. The system of claim 25 wherein said at least one predefined rule comprises at least one of a sub-element shift rule and a sub-element reorder rule.

27. The system of claim 24 wherein said computing structure transposes a plurality of said sub-elements.

28. The system of claim 27 wherein said computing structure shifts the position of a plurality of said sub-elements in a specified direction.

29. The system of claim 27 wherein said computing structure shifts the position of all of said sub-elements in a specified direction.

30. The system of claim 28 wherein said computing structure reverse orders the shifted sub-elements.

31. The system of claim 29 wherein said computing structure reverse orders the shifted sub-elements.

32. The system of claim 30 wherein said computing structure reverses the reading direction of text of the shifted sub-elements.

33. The system of claim 31 wherein said computing structure reverses the reading direction of text of the shifted sub-elements.

34. The system of claim 24 wherein said sub-elements are arranged in groups and wherein said computing structure transposes at least one of said groups.

35. The system of claim 34 wherein said computing structure shifts the position of said sub-elements in a specified direction.

36. The system of claim 35 wherein said computing structure reverse orders the shifted sub-elements.

37. The system of claim 36 wherein said computing structure reverses the reading direction of text of the shifted sub-elements.

38. The system of claim 35 wherein said computing structure reverse orders the sub-elements of a subset of said groups.

39. The system of claim 38 wherein said computing structure reverses the reading direction of text of the shifted sub-elements.

40. The system of claim 24 wherein said input is generated in response to selection of an icon associated with said transpose command presented on said display.

41. The system of claim 24 wherein said at least one GUI element is one of a window, screen, dialogue box, menu, toolbar, sidebar, icon, button, box, field, and a list.

42. An apparatus comprising:
processing structure receiving input data; and
memory storing computer program code, which when executed by the processing structure, causes the apparatus to:
determine whether said input data is associated with a command to change the display order of at least one selectable icon within a graphical user interface (GUI) element comprising a plurality of icons; and
when said input data is associated with said command, transpose said at least one selectable icon.

43. A method comprising:
receiving input; and
when said input is associated with a command to transpose a graphical user interface (GUI) element comprising a sub-element on a display, changing at least one of the position and the reading direction of said sub-element within the GUI element.
